(19) United States
(12) Patent Application Publication
(10) Pub. No.: US 2020/0355075 A1
(43) Pub. Date: Nov. 12, 2020

(54) HIGH WALL MINING METHOD

(71) Applicant: JRL Coal, Inc., Milton, GA (US)

(72) Inventor: William Quintrell, Austin, TX (US)

(21) Appl. No.: 16/408,736

(22) Filed: May 10, 2019

(51) Int. Cl. E21C 35/24; E21C 41/16; E21D 9/00; E21C 27/24; G05D 1/02

(52) U.S. Cl. CPC E21C 35/24; E21C 41/16; G05D 2201/021; E21C 27/24; G05D 1/024; E21D 9/003

(57) ABSTRACT

A high wall mining method has the steps of: providing a drilling machine with a GPS/heading locator; providing a tablet or computer accessible to cloud-based apps; downloading a software program from the cloud for high wall mining

### FIELD OF THE INVENTION

The invention is directed to improved methods to more safely and efficiently extract coal from coal seams in high wall mining. More particularly, how to greatly improve the accuracy of recovering coal through cuts forming a series of parallel rectangular cuts more accurately by creating tighter tolerances and improving the positioning of the equipment.

### BACKGROUND OF THE INVENTION

High wall mining typically has a mountain or hill with an exposed coal seam after other forms of mining the strip has been used. To best appreciate the procedure a large relatively level floor or base is formed for the mining equipment to be positioned adjacent to an exposed, virtually vertical wall of the mountain rising from the floor or base. A seam of coal runs typically along the length of the wall in a path that is readily visible. These coal seams extend deep into the mountain. These seams are sufficiently low relative to the top of the mountain making it not feasible to use strip mining

As reported in U.S. Pat. No. 8,905,487 B2 entitled “Mine Equipment Recovery System”, a good explanation of high wall mining is given. “In highwall mining, a highwall mining machine is located on the pit floor in alignment with a coal seam and a remote operated cutter module is forced into the coal seam. The cutter cuts a series of parallel rectangular cuts back into the seam up to 1,000 feet from the face of the wall. This is considered too dangerous for the insertion of any personnel and the cutter modules are directed and operated remotely. The coal mined by the cutter module is transported from the cutter module to the surface area by augers or conveyor belt systems. Typically, the cuts and the entries to the cuts are rectangular. The width of the entry to a cut is dependent on the type of cutter module used, and the width may vary from 9-½ feet to 12 feet. The height of the entry is more dependent on the coal seam's thickness, and the height may vary from 28 inches to more than 15 ft. As the high-wall miner progresses back into the mountain, a specialized form of conveyor is built behind it. This conveyor is comprised of multiple sections of push-beams. These push-beams are low profile and hollow on their interior. Within their hollow interior is at least one auger, but most typically, there are two augers. The first push-beam behind the high-wall miner receives coal, or other mined material from the high-wall miner and the augers within this first push-beam pulls the material back towards the push-beam behind it. Each push-beam receives the mined material from the one preceding it in the mine and the augers within it pull the material onward out of the mine until the material is conveyed fully out of the mine to a station at the floor of the mine pit. The augers are usually driven by the station at the exit of the mine shaft. As the mining machine recedes further underground, additional push-beams are added and pushed back in along with the machine.”

In this prior art patent, the claimed invention is a recovery device used to get the cutter and beams out of a drilled shaft after a collapse or other issue caused the expensive equipment to be stuck.

The problem of stuck machinery is extremely costly for several reasons. First, expensive mining equipment is shut down, meaning no product is being mined. Second, the cutting head and beams are expensive pieces of capital equipment if lost or damaged which hurts the mines profitably.

The present invention provides an improved way to recover the coal from a seam that avoids or greatly reduces the risk of collapsing cut walls while making the yield of recovered coal from a plan increase without increasing risk of wall collapse.

As disclosed hereinafter, in the written description is a method to more accurately form the cut walls deep into the mountain at a greatly improved tolerance that ensures the cuts are maintained extremely parallel. In the past, forming parallel cuts has been a goal, but there was no accurate way to insure it happened. As a result, the spacing between cuts had to overcompensate for tolerancing errors. Failure to do so led to deep cuts intersecting and the shafts formed to collapse. The present invention described below overcomes these issues.

### SUMMARY OF THE INVENTION

A high wall mining method has the steps of: providing a drilling machine with a GPS/Heading locator; providing a tablet or computer accessible to cloud-based apps; downloading a software program from the cloud for high wall mining; starting the program to find the drilling machine location and to find a nearest drill plan; locating a first drill hole location (1) of the nearest drill plan; directing the operator to manually position the drilling machine to the location (1), once the drilling machine is positioned the server provides from the drill plan a drill length (L) for location (1) and a heading (H) and wherein adjustments to location (1) can be made for safety by operator shifting location (1), if required; setting the drilling machine to initiate drilling of a first drill hole at the location (1); maintaining the heading (H) until the drill length (L) is achieved, the first drill hole having a left column wall and a right column wall; extracting the drilling machine from the first drill hole; marking the drilling machine location relative to an inside surface of the left or right column wall; moving the drilling machine to a next drill hole location (n) by a set distance relative to either inside surface of the left or right column wall of the last drill hole dependent on the direction of the drill plan subsequent drill holes thereby setting the location (n) of the next drill hole; aligning a drill path to be parallel to the inside surface of the left or right column wall of last drill hole using the program, the program provides the heading (H) to guide the drilling machine, the program has the heading (H) as an azimuth in degrees with an acceptable tolerance of ±⅓ degree; setting the drilling machine at the heading (H); drilling the next drill hole at location (n); the steps of positioning and drilling are repeated until the drill plan is completed.

The drill plan is established by a surveyor drawing a first line for a seam and a second line establishing a drill limit, the surveyor then provides the heading (H) for the drill holes. The pattern drill plan for all holes stop at the second line which sets the drill limits and the heading line. The tablet or computer with the downloaded program inputs the drill plan of the surveyor to give drill location (1) and heading (H). The drilling machine operator can adjust the drill plan location (1) and heading for safety rules and the program adjusts to the shifted location (1) or heading (H). The program is set to skip each consecutive set drill hole after a preset number is reached. The preset number is set to skip the 20th consecutive location. The program has a screen with an alignment heading indicator that shows a green or acceptable position when the machine is moved to provide a next drill hole within ±⅓ degree, based on the heading (H) of the last drill hole.

The drilling machine uses beams of a set length (LB), the machine operator adds beams by pulling back slightly, inserting a new beam and resuming drilling by pushing, the program records each beam added in real time as a hole is drilled. A drill plan is completed when no more possible drill holes or projection of drill holes can be made. The program provides data on each tablet or computer which is transmitted to the cloud in real time allowing the mine management and the surveyor to get a next adjacent drill plan available. The mine locations have the high wall being prepared for mining by equipment to make a substantially vertical wall and a level ground platform or floor for the drilling machine. The surveyor adjusts the plan for the mountain shape and when completed, uploads the survey plan to the program. The program records real time mining detail and provides the volume amount of coal extracted per hole and per shift automatically. The program allows machinery and crew productivity measurements and comparisons per hole and per shift. The program records a record of drilled holes for each plan and is programmed to produce true and accurate CAD drawing files in minutes for permanent record keeping to be kept and stored.

### BRIEF DESCRIPTION OF THE DRAWINGS

The patent or application file contains at least one drawing/photograph executed in color. Copies of this patent or patent application publication with color drawing(s) will be provided by the Office upon request and payment of the necessary fee.

The invention will be described by way of example and with reference to the accompanying drawings in which:

FIG. 1 is a photograph of a high wall mine showing the cut holes.

FIG. 2 is a view of the tablet screen with the software or app showing the heading and the location to add beams to being a cut or hole.

FIG. 3 is a view of the tablet screen with the software or app showing the acceptable area or zone for the next hole.

FIG. 4 is a view of the tablet screen with the software or app showing a report of equipment production with feet advanced, tons extracted, pounds per foot and holes started.

FIG. 5 is a view of the tablet screen with the software or app showing equipment progress over a period of time.

FIG. 6 is a view of the tablet screen with the software showing possible locations of cuts or holes to be made.

FIG. 7 is a view of the tablet screen with the software showing the current progress of drill plan #25 with holes completed shown in blue and holes to be made shown in orange with the completed stats and estimated completion data.

FIG. 8 is a view of the tablet screen with the software showing status of HW145 and HW146 mining equipment.

FIG. 9 is a view of the tablet showing an image of the mining equipment and the progress of a hole being made.

FIG. 10 is a view of a HWM/Auger project screen inventor page.

FIG. 11 is a representation of the wireless connections of the Highwall miner, Auger and Safety Building.

FIG. 12 is a view of the tablet screen with the software showing the main drill plan map view.

FIG. 13 is a view of the tablet screen with the software showing the main drill plan map view with available options.

FIG. 14 is a view of the tablet screen with the software showing the manage map layers options.

FIG. 15 is a view of the tablet screen with the software showing stage 4: begin drill plan indicating the machine needs to move closer to wall.

FIG. 16 is an exemplary screen view showing where the machine needs to move to be closer to the hole and align.

FIG. 17 is the exemplary screen view of FIG. 16 showing the machine needs to move more to be aligned.

FIG. 18 is the exemplary screen view of FIG. 16 showing the machine is not aligned and ready to start drilling.

FIG. 19 is an exemplary screen view showing the machine in the process of drilling a hole with the option to pause machine.

FIG. 20 is the exemplary screen view of FIG. 19 showing the machine retracting after completing the hole with options for “pause machine” and “hole completed?”.

### DETAILED DESCRIPTION OF THE INVENTION

The primary goals of the described system are to: 1. Enable the Surveyor to quickly define a new drill plan providing minimal information and effort. 2. Construct or project an optimal drill plan give the surveyor information and all known mining rules and constraints. 3. Automatically transmit the right drill plan to the right machine on demand without using any manual data exchange methods such as USB storage devices or cables. 4. Direct the operator to position the machine at the next ideal position. a. Using machine position, heading and embedded rules to optimize pillar walls for integrity while maximizing the amount of coal extracted in plan's available stretch of seam. 5. Adapt to the operator's local knowledge and site situation to dynamically adjust the plan typically due to observed site safety concerns. 6. Provide real time hole and plan events and metrics to the cloud-based data repository. 7. Provide real time status and progress dashboards to supervisors, surveyors and management. 8. Quickly generate precise CAD drawings of actual hole details avoiding manually surveying completed holes and using imprecise, manual estimates of hole lengths.

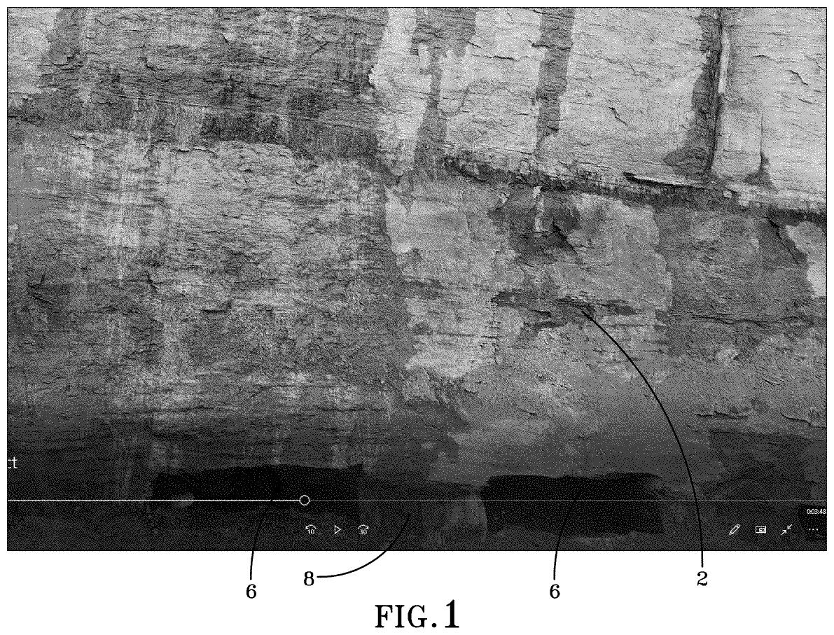

In high wall mining (HWM) an initial or first step is having a surveyor make a simple rough sketch. The surveyor draws a wall line (WL) representing the wall location and then draws a second line called a drill limit (DL). The drill limit (DL) is the surveyor's not-to-exceed estimate of the distance or depth of the drilling into the mountain. The surveyor then draws a heading line (H) between the wall line (WL) and the drill limit line (DL). The heading (H) is the direction the surveyor provides for the mine operator to orient his equipment/drilling machine to drill the initial hole or cut at a first cut location 1. From this, based on a set of rules for drilling, the entire surveyor pattern plan or drill plan for all subsequent cuts or holes is set. The entire drill plan is built on the surveyors initial three lines, as shown in FIG. 1.

Each mining company can have their own set of rules or guidelines. In the exemplary mining operation of the present invention after every 20 drill holes is made the operator skips a drill hole area.

The machine has a tablet, in the present invention, an ANDROID® device from Samsung, which executes a browser-based Progressive Web App from the cloud, nothing is installed in the tablet. The tablet can be any network-connected electronic computer or laptop or IPAD® type device. The operator selects the shortcut to go to the High Wall Management System to start, the drilling machine has GPS/heading, finds the location, the app says here you are and here is closest drill plan and directs the first drill position. The operator manually positions the machine.

The tablet screen gives location 1 and heading 2. The operator can adjust the drill plan for safety and should a hole need to shift, the entire remaining plan adjusts based on actual adjusted location 1 using the internal plan rule hierarchy.

The goal is twofold: 1) ensure holes are perfectly parallel and 2) ensure holes as close as possible while maintaining pillar width requirements. This maximizes the coal extracted and profits for any drill plan.

Once cut, based on rules, the machine pulls back from the last beam, inserts a new beam, then the series of coupled beams is pushed to resume cutting. The software records beam addition event and in real time as the hole is drilled.

The plan is completed when no more possible projections (holes) can be made which would satisfy the wall, limit and pillar rules.

The system maintains date/time-stamped detailed mining events and in less than a minute it can generate a detailed CAD drawing file for inclusion in mine site documentation. Historically this detailed survey and CAD drawing has required 3 to 4 days to complete. This is a huge time saver for the survey teams.

In 2019, a hole collapse can trap a cutter head costing $600,000 with scores of beams attached, each beam costs $15,000. This can create a huge financial loss. Further, loss production time due to trying to free a trapped head/beams costs $40,000 each day in coal not mined. This system should reduce the risk trapping head/beams and lost productivity potentially several time during the life of the machine.

With reference to the drawings, FIG. 1 is a photograph of a portion of a substantially vertical wall 2 having a coal seam 4 shown in a lower portion where several rectangular shaped drill cuts 6 have been made between each cut 6 is a column or pillar wall 8. Each column or pillar wall is provided to support the mountain and prevent collapsing into the drilled cut 6 or shaft. As shown, the cuts 6 extend into the mountain with the goal being each cut 6 is parallel so as to maintain the column or pillar wall thickness adequate to prevent collapsing. In high wall mining, prevention of drill cut collapses is essential. Failure to accommodate sufficiently for drilling tolerances can result in the shafts intersecting. To provide safety margins, the column walls are spaced farther apart than otherwise would be required. This means less coal can be extracted from a drill plan or given stretch of coal seam 4. The present invention provides a unique way to precisely manage the tolerances and improve the drilling accuracy to allow more coal to be mined at less risk.

FIG. 1 is an example of what the high wall miner sees, the side of a wall 2. At the bottom are rectangular holes 6 where the miner has slid the beams 20 into the seam of coal 4 going back hundreds of feet removing the coal 1. Then a space is skipped between holes 6 creating a pillar 8 that supports the wall 2. Then another hole is drilled using the present invention to line up the next hole at the correct heading, track the depth and progress on that hole 6. After a hole 6 is completed, the software determines the next hole 6 with the proper pillar 8 length or thickness to prevent going too far and leaving coal 10 or not going far enough and creating a safety risk. The holes 6 are drilled precisely with the next hole 6 precisely parallel with the last hole 6 using the drill plan heading to prevent holes diverging and leaving too much space and wasted coal or converging and leaving too little pillar 8 to provide the required stability.

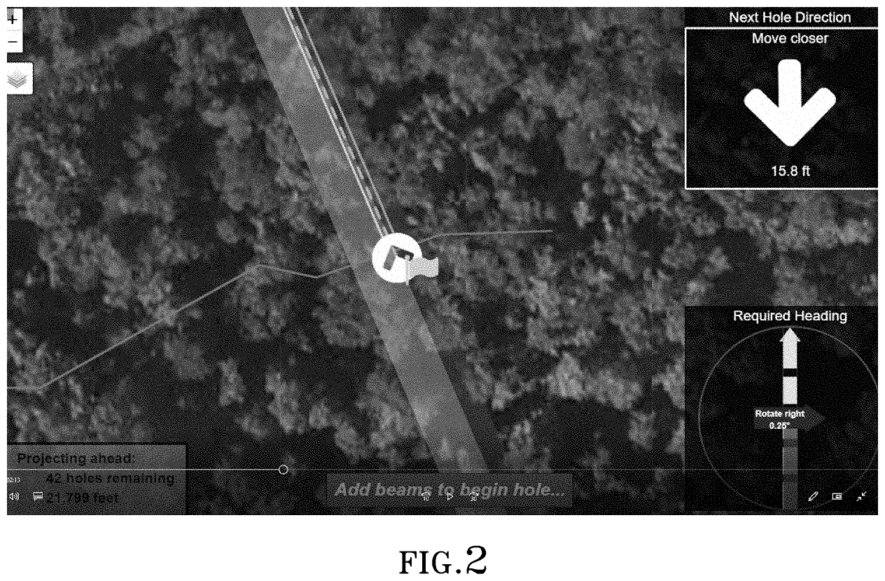

FIGS. 2-20 show screen shots taken from a tablet 200 that has a cloud-based mining software application executed to assist the high wall mine equipment operator execute a drill plan safely and efficiently.

FIG. 2 is an example of the positioning screen that the operator sees. The program places a flag image on the screen overlaying a satellite image recommending where to locate the machine 100. This is only a recommendation in case the location needs to be slightly altered by the operator. The white circle represents the machine 100 with an arrow inside the circle showing the direction the machine is traveling. If the machine were not heading in the correct direction, a required heading box on the screen would show a red arrow and movement directions for rotating the machine to correct the heading. If the flag location is ideal, the upper right corner of this screen has a white arrow with directions to move closer a certain distance indicating where the operator needs to move the machine for proper placement of the next hole. The red band to the right of the green band indicates this is not a safe area for drilling the next hole, the best area is just inside the green area where the flag is located. This creates the smallest possible pillar wall 8 within the regulation and safety limits with optimum coal production. This screen indicates in the bottom message area that it is acceptable to “add beams to begin hole” once the machine is in the proper heading. There is also a message box in the lower left corner showing the current plan holes remaining and feet.

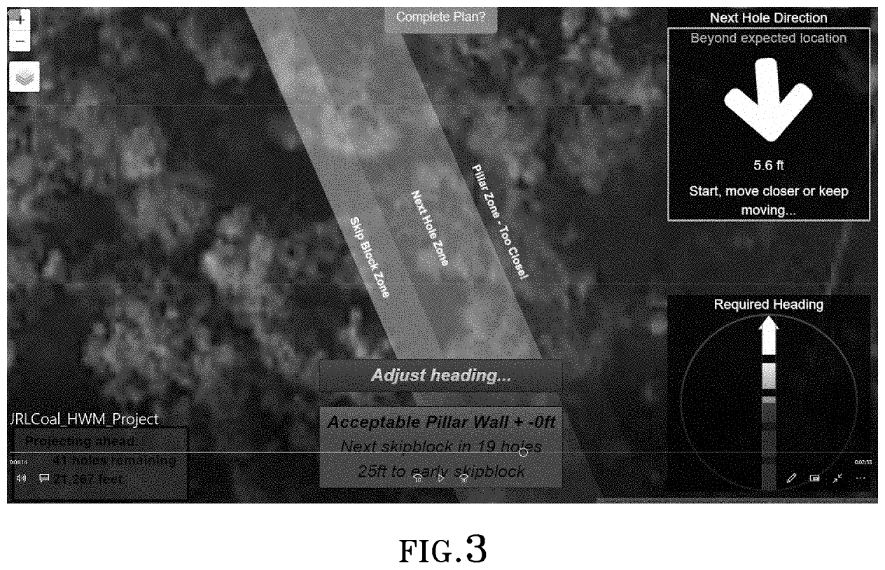

FIG. 3 is a zoomed in view of a screen similar to FIG. 2. This shows the red band indicating the pillar zone that is not to be drilled in. The green band indicates the acceptable area for the next hole, preferably as close as possible to the red pillar zone. Next to the green band is a tan band indicating a skipblock zone which is an area to be skipped with no drilling possibly for a safety reason such as loose rock on the wall or a sharp turn in the wall or a required area to be skipped. There is a requirement that is entered in the program for a hole to be skipped after a certain number of holes, in this case every 20^{th} hole is skipped. If the skipblock zone is for reasons other than the requirement, it could be an opportunity to meet the requirement to skip a required block at this time saving a skipped area that may be able to be drilled in later. So, for example, the operator is on hole n=15 and can't drill there, he skips that location and the next skip hole is 20 downstream or at cut 35. This screen also shows the arrow at the top right indicating the machine has moved beyond the expected location and in the bottom right that they are not in the required heading. In the lower center is a message to “adjust heading” and below that is a box with the acceptable pillar wall, next skipblock and how many feet to early skipblock.

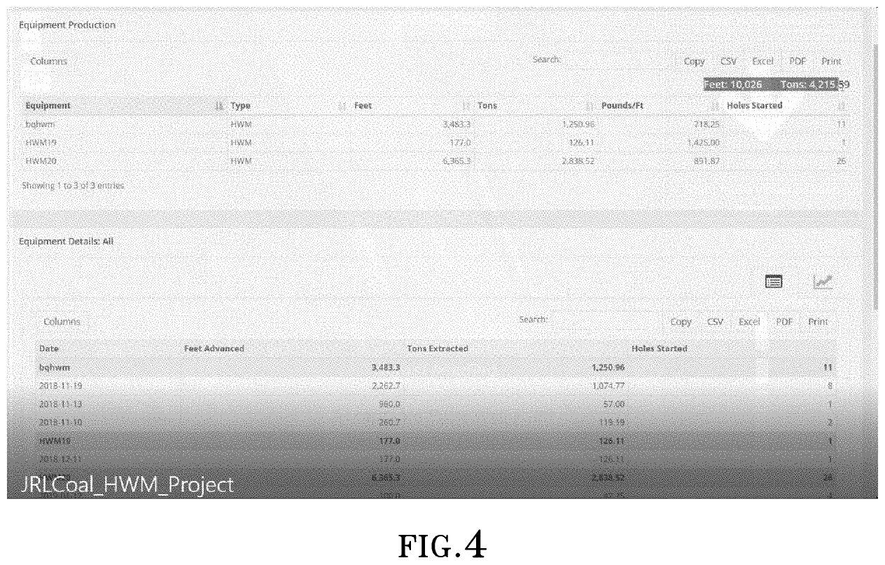

FIG. 4 shows a screen console dashboard on the business system at the main site. Management, supervisors, surveyors, etc. can use this at any time to see the progress of the high wall miners and their progress in the drilling process. It displays how many feet advanced, how many holes were started and based on the thickness of the seam they are working in, tons extracted. For example, a high wall miner may have just started a shift in a hole and is advancing, pushing beams. The second high wall miner may have started a shift finishing a hole, having to reposition and then going back and beginning to push beams. This screen gives an idea of how many times a miner may have moved a machine during the time frame displayed and thus explain why one machine's extraction may be different from another machine in the same timeframe. The view can be set for a variety of time frames such as, day, week quarter, etc. A supervisor would likely look at today, whereas management may look at weekly progress. The detail at the bottom can be selected to show the details generating the totals at the top of the screen.

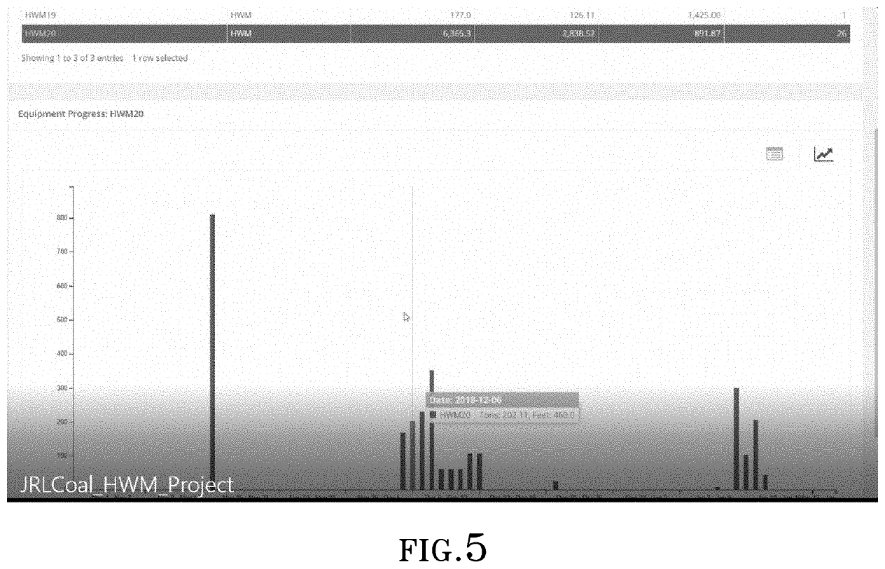

FIG. 5 is a graphical representation of the data from FIG. 4. Hovering the cursor over a bar on the graph shows the date, the miner, tons and feet. This allows the progress of the miners to be displayed as a graph over a period of time. The amount of a particular machine's downtime is easily seen on this type of graph.

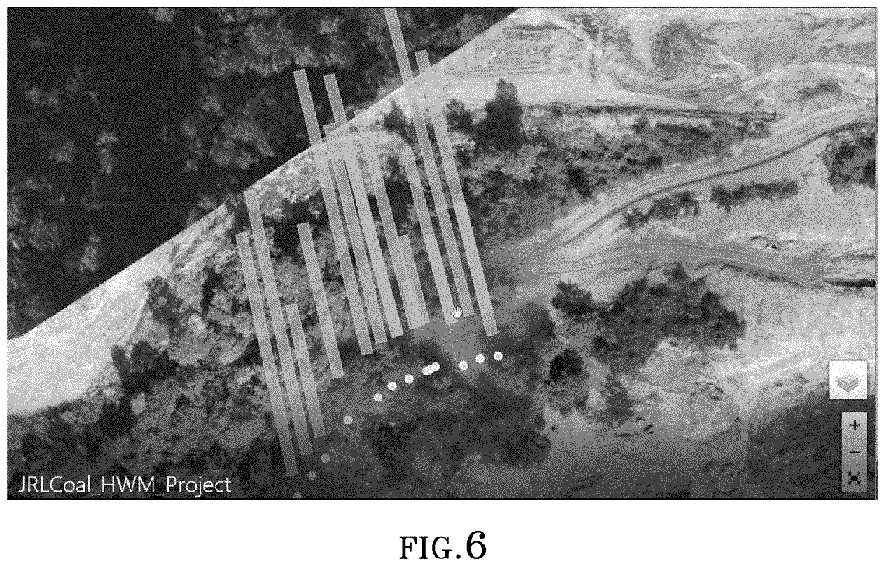

FIG. 6 is a screen that can be viewed by surveyor's, management, etc. in the business system. The view shows the drill plan progress of a particular machine. The yellow dots show where the machine was actually sitting. The machine is spaced from the wall which is shown as a green rectangle beginning where the drilling is started extending to where the drilling is completed. This is shown as a documented history of the actual drilling that was completed opposed to what was planned. It is important to have good documentation of where the holes are throughout the site with elevations and distances. This information is collected real-time which allows surveyors, site preparation crews to go online quickly and see how far a machine has progressed in the drill plan and determine when they will need to be ready for the next drill plan. This is archived forever and becomes a permanent part of the site.

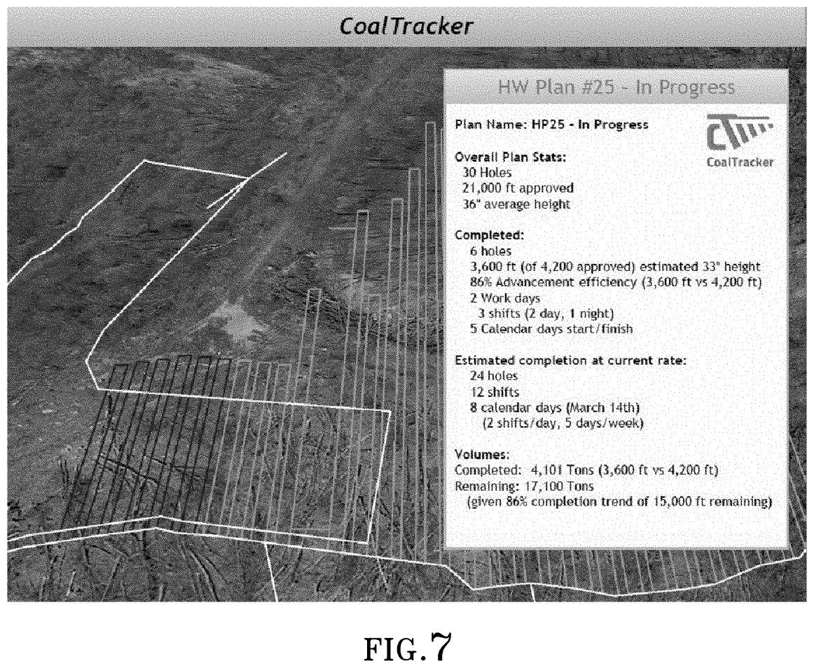

FIG. 7 is an earlier view of what is completed and what remains to be done in the drill plan. The “In Progress” portion of the screen shows the overall plan; portion completed holes, feet, percentage, etc; estimated completion needed and volumes. Note: just because the surveyor approves a miner to go a certain distance in the hole length, does not mean they can or do. There can be situations such as an underground stream or water that causes a hole to be stopped early preventing the machine operator from going the full distance the hole was approved. The system analyzes the actual distance the miners have been going in holes compared to what was allowed for them to go and then calculates the actual vs allowed percentages. This percentage is used as a basis in the completion trend estimates for projecting expected coal extraction from the remaining plan holes, in this example 86% of allowed hole lengths is expected.

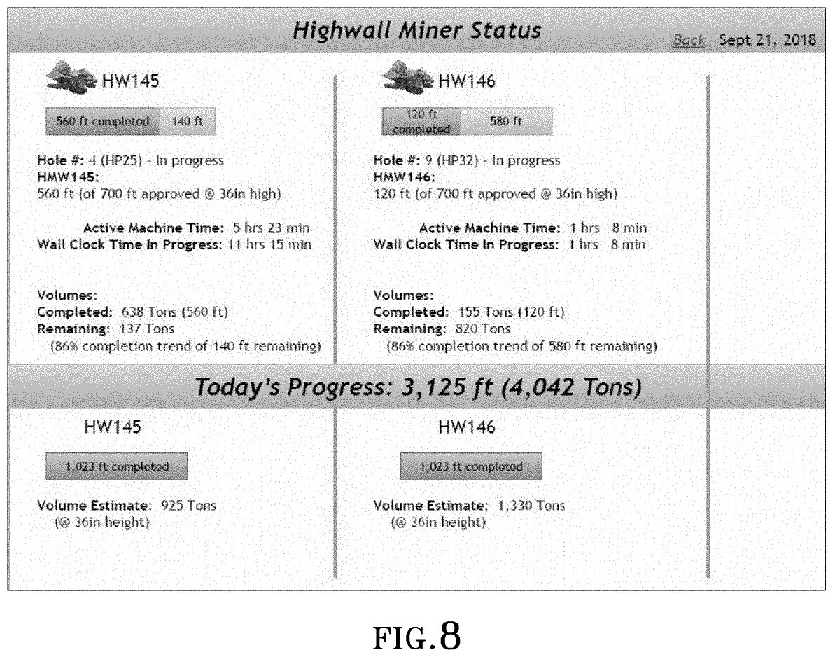

FIG. 8 is a dashboard screen used by management centrally to view an overall status of the machines progress and what are they doing right now. It is a summary for each machine and overall for the mine operation between all the machines how much has been produced as a total.

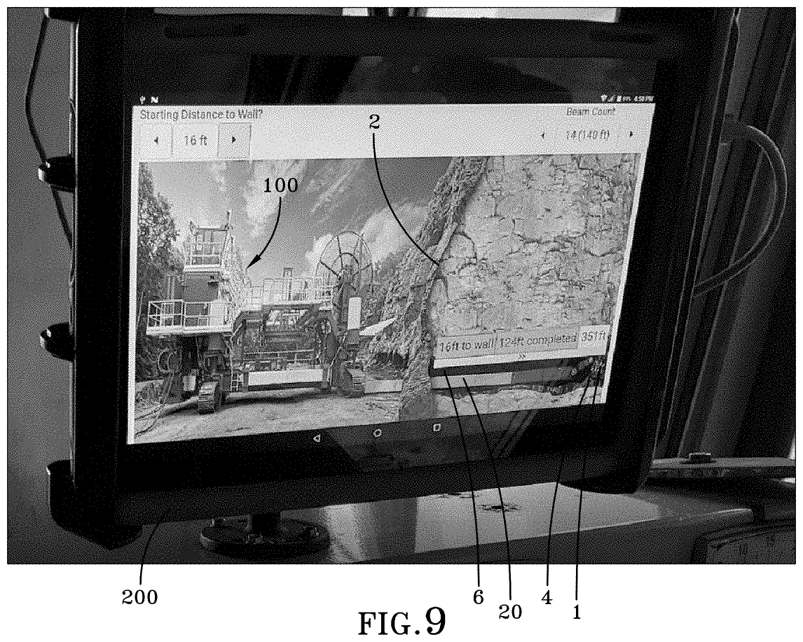

FIG. 9 is an actual live shot of the tablet 200 mounted inside the high wall miner machine 100. This screen shows the machine 100 positioned drilling into the seam. The drill screen shows the machine is 16 feet back from the wall, 124 feet have been drilled so far and are approved to go another 351 feet. The screen shows as they add beams and drill into the wall, the progress of a particular hole.

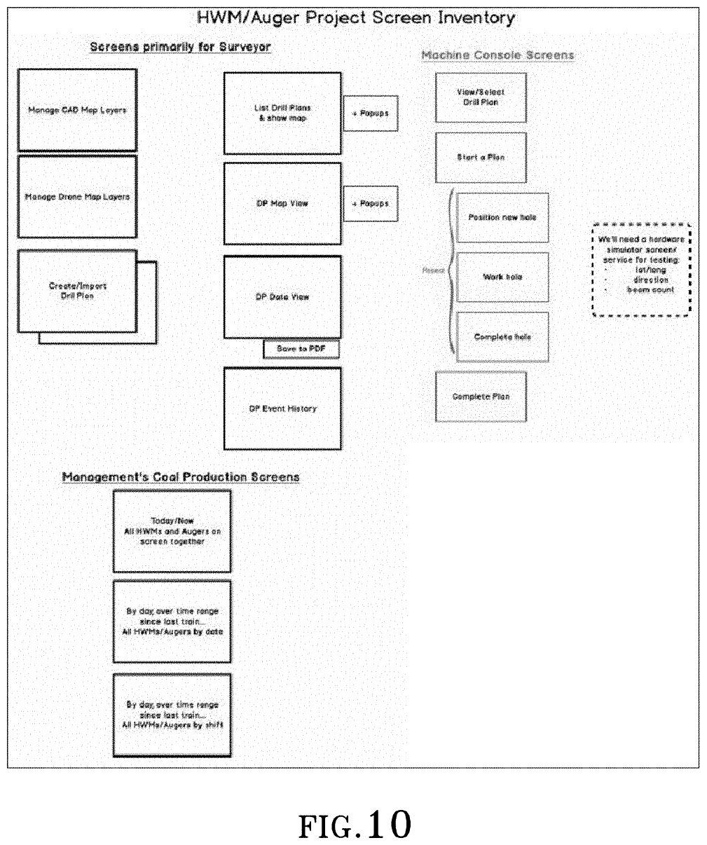

FIG. 10 shows a mockup showing the design of the system as an inventory of screens. The blocks represent screens needed in the system. This maps out the various app screens and who would be focused on which screens. For example, the operator would use the machine console screens with the plans, hole positions, position to new hole, a screen to work the hole, distance progress, adding beams, finally they complete the hole and they specify why they stopped where they stopped, did they run into an obstruction, was there some issue or did they go the full distance. They respond to that question, then repeat to the next hole and repeat until they get to the end of the plan which is the typical work flow for a machine operator. The surveyor screens focus on registering a new drill plan. They would create and import a drill plan from the CAD system into the High Wall Miner system. They can list all the drill plans being worked by miners currently, which plans are pending or view the history of past drill plans. they can change various map views versus data views of those plans. There is a set of screens to look at detailed events. What date/time was machine positioned on the hole, what's the date/time location of the first beam it put out, the second beam, third beam, so you drill into this with an analytical tool and do things like shift productivity or machine productivity. The dash board screens show the progress in a date/time range and all the machines and what they produced.

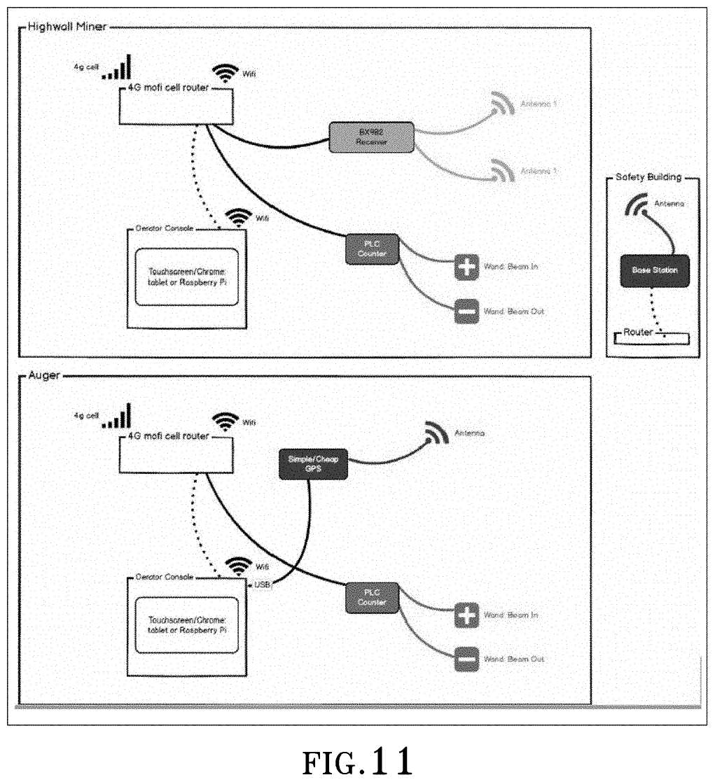

FIG. 11 shows the high wall miner connectivity wiring standpoint. There are basically three functions on the machine itself. First, we need very accurate GPS heading information, we chose a Trimble BX982 receiver with its pair of antennas. This is on the machine and gives us the machine position and which heading direction it is pointing and that is plugged into a network that is created on the machine so we can communicate with this device. Then there is a small PLC, programmable logic controller, counter device with a sensor on the machine that knows each time a beam is added or removed. It increments or reduces the counter to keep up with the count of beams which tells you how many feet they have advanced through the mountain, how many feet they have drilled. That is connected into the network on the machine. The touchscreen the operator uses is connected to the same network but using Wi-Fi as opposed to a wired cable like the other two devices. Thus, there is the local network of our console reading the machine GPS/heading information, beam counters and monitoring those while at the same time this network is connected over a cell network to the main cloud-based system. That is where the primary data and management information is being stored and managed. The Auger is another type of machine that drills into the mountain, similar to the miner, but more simplified device operating on a smaller scale. The augur does not have the same pillar heading requirements for positioning but instead uses heading to document actual/completed holes. In our design we mapped out a lower-cost hardware configuration that could be implemented for augers.

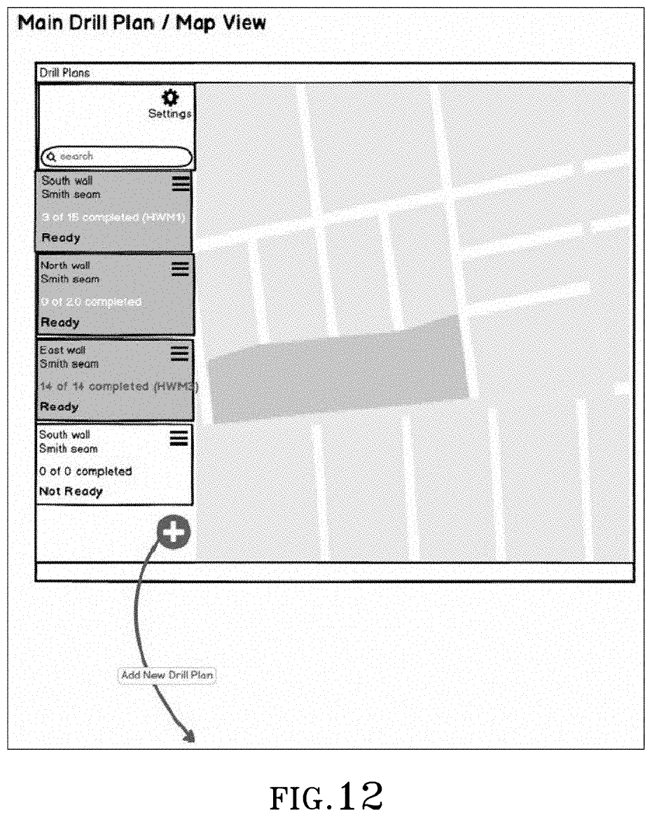

FIG. 12 shows a mockup of the coal tracker screen where you could see the list of drill plans that have been uploaded into the system, the plan names and which seams they relate. The mockup is showing that at this moment on the South wall HWM1 has completed 3 of the 15 holes in this plan. The North wall plan is uploaded and ready, but no machine has started working on it. The East wall plan shows HWM3 has completed all 14 holes in this plan. And finally, at the bottom is a new South wall plan which has been uploaded but is in the “Not Ready” state and unavailable to machines because the surveyor has not yet released this to be worked.

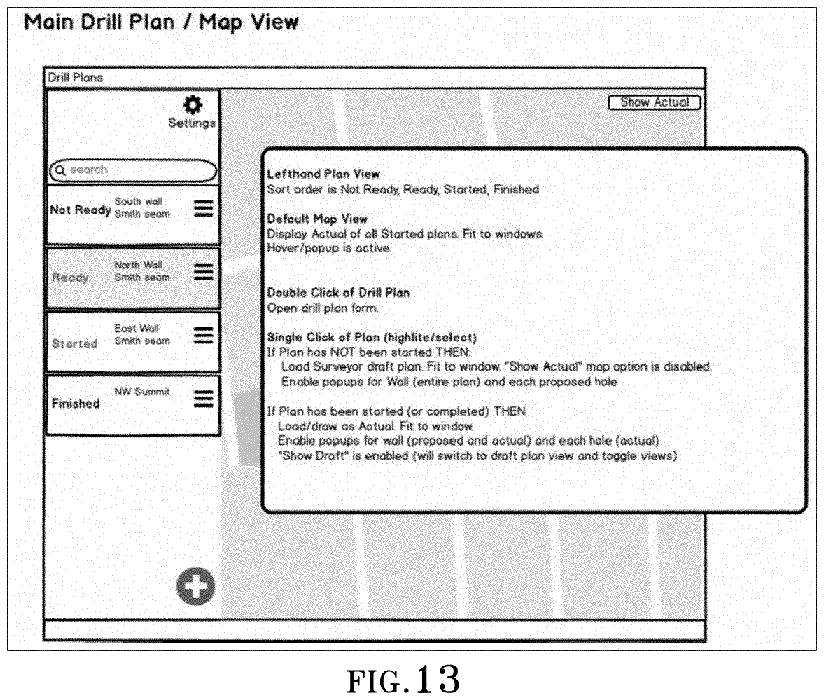

FIG. 13 shows exemplary programmer instructions, not needed by the actual users per se.

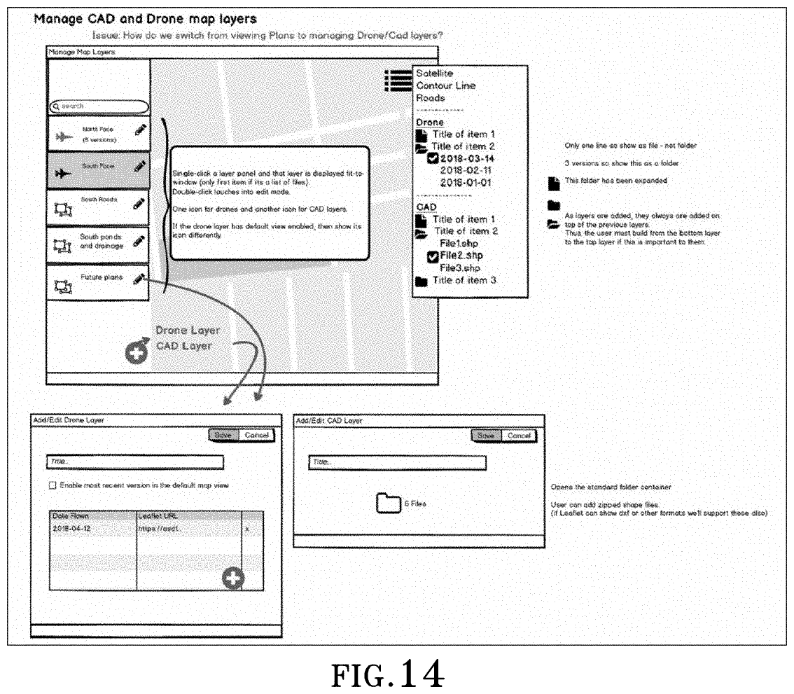

FIG. 14 shows an extra feature where the system connects to a third-party drone flight system, where you can fly the drones over the area and create map tiles. The drone map tiles are placed over the current map as opposed to showing what the current google map might be. The issue being addresses here is that the map providers are not flying over these back-wood mountain areas keeping their satellite maps updated. This feature was added so the surveyors can fly the area with a drone, point our system to the drone maps and will display a more current, realistic map view the actual wall line thus providing more situational awareness.

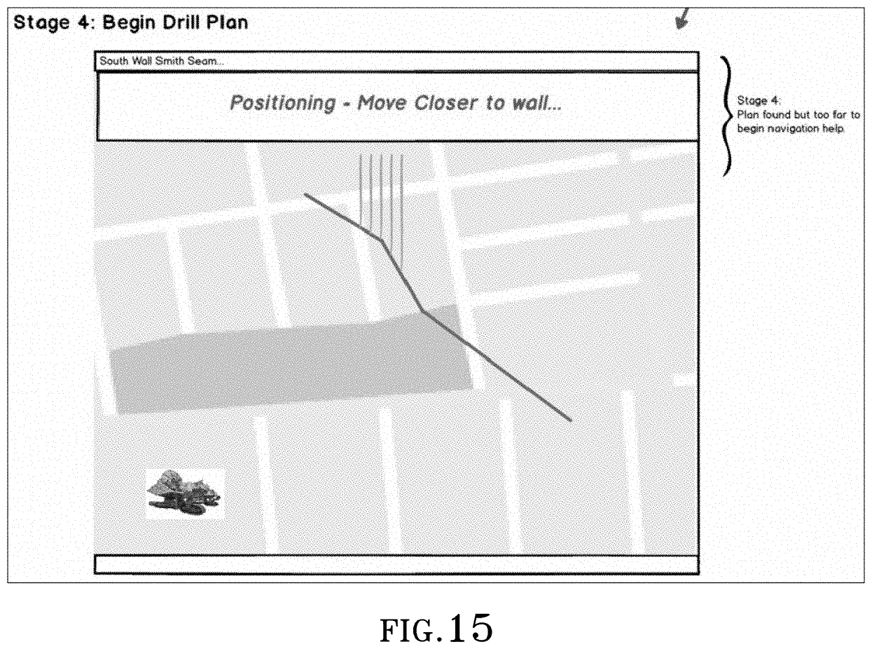

FIG. 15 is a mockup to begin a drill plan to move the machine closer to the drill wall.

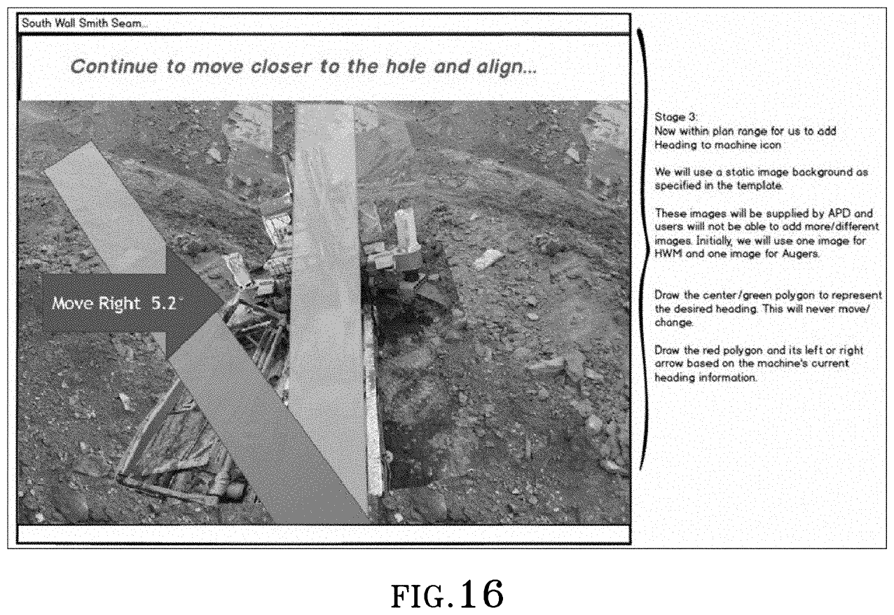

FIG. 16 was an early mockup to show getting the heading right and how to inform and direct the operator. FIG. 2 shows the current version and is believed more user friendly.

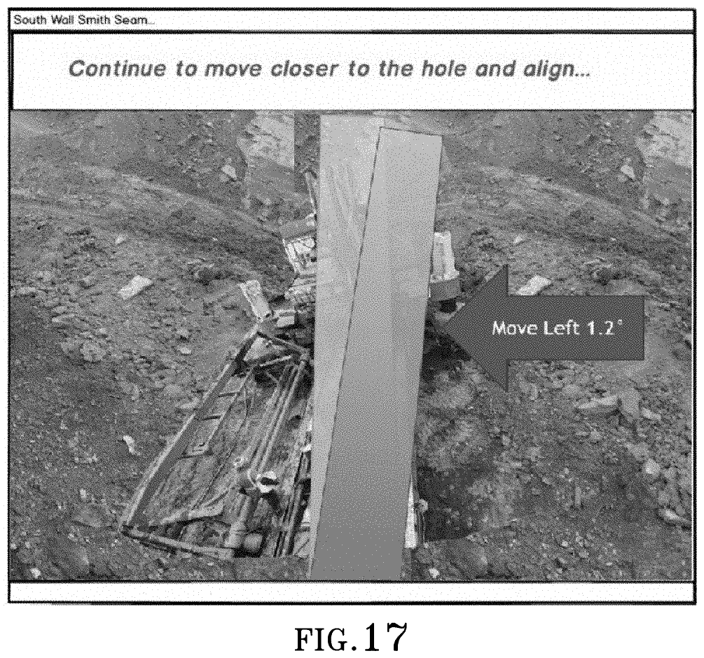

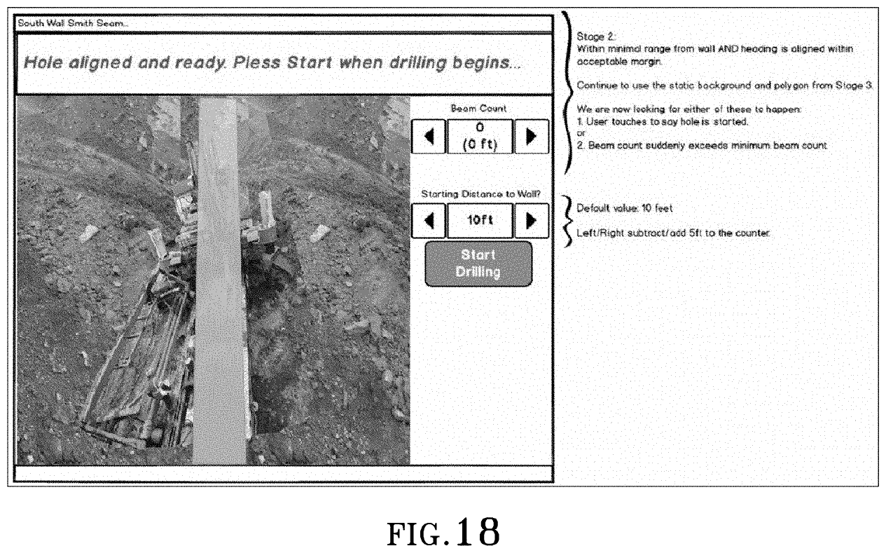

FIGS. 17 and 18 are early mockups showing perfect positioning.

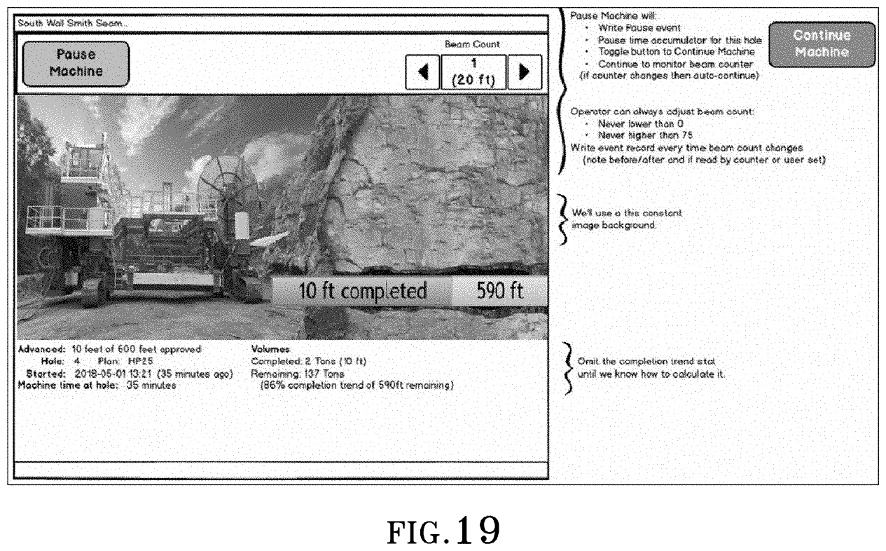

FIG. 19 was an early program mockup of FIG. 9 drilling in.

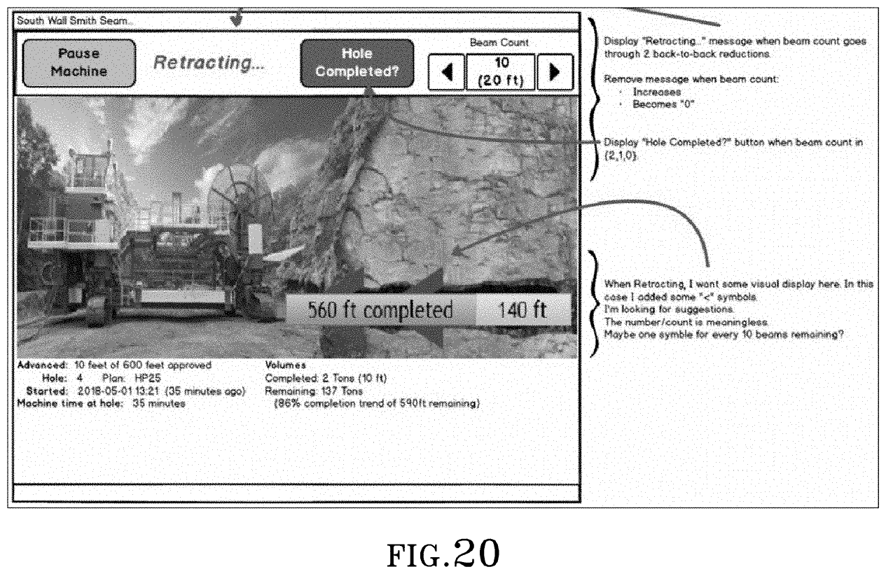

FIG. 20 also an early version of FIG. 9, shows beams retracting pulling out beams.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A high wall mining method comprises the steps of:
providing a drilling machine with a GPS/heading locator;
providing a tablet or computer accessible to cloud-based apps;
executing a software program from the cloud for high wall mining;
starting the program to find the drilling machine location and to find a nearest drill plan;
locating a first drill hole location (1) of the nearest drill plan;
directing the operator to manually position the drilling machine to the location (1), once the drilling machine is positioned the server provides from the drill plan a drill length for location (1) and a heading (H) and wherein adjustments to location (1) can be made for safety by operator shifting location (1), if required;
setting the drilling machine to initiate drilling of a first drill hole at the location (1);
maintaining the heading (H) until the drill length (L) is achieved, the first drill hole having a left column wall and a right column wall;
extracting the drilling machine from the first drill hole;
marking the drilling machine location relative to an inside surface of the left or right column wall;
moving the drilling machine to a next drill hole location (n) by a set distance relative to either inside surface of the left or right column wall of the last drill hole dependent on the direction of the drill plan subsequent drill holes thereby setting the location (n) of the next drill hole;
aligning a drill path to be parallel to the inside surface of the left or right column wall of last drill hole using the program, the program provides the heading (H) to guide the drilling machine, the program has the heading (H) as an azimuth in degrees with an acceptable tolerance of ±⅓ degree;
setting the drilling machine at the heading (H);
drilling the next drill hole at location (n);
the steps of marking through drilling are repeated until the drill plan is completed.

2. The high wall mining method of claim 1 wherein the drill plan is established by a surveyor drawing a first line for a seam and a second line establishing a drill limit, the surveyor then provides the heading (H) for the drill holes.

3. The high wall mining method of claim 2 wherein the pattern drill plan for all holes stop at the second line which sets the drill limits and the heading line.

4. The high wall mining method of claim 3 wherein the tablet or computer with the downloaded program inputs the drill plan of the surveyor to give drill location (1) and heading (H).

5. The high wall mining method of claim 4 wherein the drilling machine operator can adjust the drill plan location (1) and heading for safety rules and the program adjusts to the shifted location (1) or heading (H).

6. The high wall mining method of claim 5 wherein the program is set to skip each consecutive set drill hole after a preset number is reached.

7. The high wall mining method of claim 6 wherein the preset number is set to skip the 20^{th} consecutive location.

8. The high wall mining method of claim 7 wherein the program has a screen with an alignment heading indicator that shows a green or acceptable position when the machine is moved to provide a next drill hole within ±⅓ degree, based on the last drill hole of the heading (H).

9. The high wall mining method of claim 8 wherein the drilling machine uses beams of a set length (L_{B}), the machine operator adds beams by pulling back slightly, inserting a new beam and resuming drilling by pushing, the program records each beam added in real time as a hole is drilled.

10. The high wall mining method of claim 1 wherein a drill plan is completed when no more possible drill holes or projection of drill holes can be made using the provided wall line, limit line and heading of the last hole.

11. The high wall mining method of claim 1 wherein the program provides data on each tablet or computer which is transmitted to the cloud in real time allowing the mine management and the surveyor to get a next adjacent drill plan available.

12. The high wall mining method of claim 1 wherein the surveyor adjusts for the mountain shape and when completed, uploads the survey plan to the program.

13. The high wall mining method of claim 1 wherein the mine locations have the high wall being prepared for mining by equipment to make a substantially vertical wall and a level ground platform or floor for the drilling machine.

14. The high wall mining method of claim 1 wherein the program records real time mining detail and provides the volume amount of coal extracted per hole and per shift automatically.

15. The high wall mining method of claim 1 wherein the program allows machinery and crew productivity measurements and comparisons per hole and per shift.

16. The high wall mining method of claim 1 wherein the program records a record of drilled holes for each plan and is programmed to produce true and accurate CAD drawing files in minutes for permanent record keeping to be kept and stored.
